(19) United States
(12) Patent Application Publication
(10) Pub. No.: US 2006/0222443 A1
(43) Pub. Date: Oct. 5, 2006

(54) MARKER IMPLEMENT

(76) Inventors: Eileen Savage, Atlanta, GA (US); Kathleen Luck, Atlanta, GA (US); William David Withers, Atlanta, GA (US)

Correspondence Address: DUANE MORRIS, LLP;IP DEPARTMENT, 30 SOUTH 17TH STREET, PHILADELPHIA, PA, 19103-4196, US

(21) Appl. No.: 11/278,445

(22) Filed: Apr. 3, 2006

Related U.S. Application Data
(60) Provisional application No. 60/668,359, filed on Apr. 4, 2005.

(51) Int. Cl. B43K 8/00

(52) U.S. Cl. 401/196

(57) ABSTRACT

A marking tool has pigmented material integrally formed into a marker tool shape with various corners and edges that are usefully deployable. A planar body has spaced preferably parallel faces defining a thickness, and spaced peripheral sides oriented orthogonally to the faces. One or more sides can be curved. A number of straight or curved edges are formed between the faces and sides, with corners where three surfaces intersect and form a point. Some of the surfaces are segments that can be passed perpendicularly, at an incline or along the line of the edge to vary mark thickness. The marker is useful for drawing and shading when sketching, making lines in construction trades, arts, rubbing to trace bas-relief patterns, etc.

### CROSS REFERENCE TO RELATED APPLICATION

This application claims priority of U.S. provisional patent application Ser. No. 60/668,359, filed Apr. 4, 2005.

### BACKGROUND OF THE INVENTION

1. Field of the Invention

The invention relates to manual marking implements and applicators for shading or coloring compositions, particularly in the nature of a pencil-like marking tool for artists, craftsmen and the like.

2. Prior Art

There are various styles of drawing sketches and various sketching techniques for applying a contrasting composition to paper or another medium. Often it is desirable to sketch using an implement that is amenable to revision. For this reason, pencil tools that typically employ graphite marking media are often used for sketching and other purposes.

Pencils conventionally may be static assemblies or may have movable mechanical parts. A quantity of marking material is provided, typically as a thin elongated cylinder or the like, shaped to be used as a stylus. The marking material is worn away in use and can be exposed by removing a covering material (i.e., by “sharpening” the pencil) or in a mechanical arrangement the material is fed by an incremental advancing mechanism relative to a casing, so as to protrude at an end that is applied to the paper or other medium for making pencil marks.

Mechanical pencils are much the same as pens in that the devices are best adapted for making lines on the paper. A regular stylus pencil is similar but has an elongated cylindrical marker or “lead” part (typically bonded powdered graphite) permanently mounted in a wooden shaft. Such a stylus pencil is sharpened by removing a conical portion of the marking wooden shaft around an exposed tip of “lead” (graphite).

A pencil produces a mark by abrading material from a marking medium that contains a pigment material integrally bonded with a binder. For example, a pencil may comprise graphite powder mixed with clay and baked. Rubbing the pencil point over paper or some other surface causes the marking material to wear away from the surface of the marking material at the point of contact, being left on the surface as a line or streak of a width equal to the area of contact. The composition of the marking material is graded. The marking material may be relatively “soft,” meaning easily removable from the binder so as to leave a relatively dark mark with relatively light contact, but often being messy, difficult to erase cleanly, and quickly becoming dull at the point and in need of sharpening. The opposite situation for “hard” material is that the material is clean and holds a point, but may leave a mark that is rather too light.

Apart from the nature of the marking material, the structure of the exposed marker material point also determines what sort of mark will be made. A pen or pencil or the like may possibly make a line of a greater or lesser width in one stroke. The width of the mark left by a stroke is comparable to the dimensions of the point of the marker tool where the point meets the paper. A pencil point can be sharpened and applied endwise to leave a thin line in the same way that the point of a pen leaves an ink line with the width of the pen tip. A pencil point often is sharpened to a conical point. Such a point can leave a thin line when applied endwise or a controllably wider line if applied so as to rub the conical side of the point on the paper. In this way a pencil can be used to make varying lines but the maximum width is equal to the exposed length of the marker material at the side of the conical point.

Within the general class of stylus pencils as described are those that are adapted for particular uses. Carpenters' pencils often are provided with elongated flattened bars of relatively hard marker material, in a flattened wooden shaft. Large diameter pencils are used in early elementary schools. These particular pencil forms are useful because there is a need to avoid breaking the lead point, and possibly less need for a thin line. It is nevertheless necessary to sharpen the point from time to time, e.g., with a rotary abrading sharpener or with a penknife or other cutting tool.

The foregoing discussion refers substantially to graphite pencils; but the specific nature of marker materials can be wide ranging. Whereas pencils frequently use bonded black graphite powder as the marking agent, colored pencils may use other marker materials. The marking agent may be relatively harder or softer, dryer as in a chalk maker, waxy or oily as in a crayon, etc. The marking agent also can be carried in a wood or paper or other carrier or exposed on its surface.

Artists sometimes use pencils for sketching but also find it useful to apply bulk marker material to paper or other media over a long edge, to facilitate shading. Charcoal sketching and the like are possible using a lump of material without too much regard to the shape of the lump. Furthermore, using the lump for marking allows one over time to modify the shape of the lump, e.g., to provide exposed surfaces of different characters. Nevertheless, it is conventional for exposed marker materials such as charcoal, chalk or other contrast material to be elongated sticks that have either a flattened bar shape (a rectangular cross section) or a cylindrical shape (a circular cross section).

An elongated marker can be applied endwise to make a thin line of a width comparable to the width of the marker material. The end can be formed at an angle to provide the option of thicker lines (similar to using the conical side of a pencil point). If the marker material is exposed along an entire side, either a thin line or thick line is possible by choice of marker orientation. The thickness can be controlled by varying the relative orientation of the axis of elongation of the marker, versus the path of propagation of a marked line. The maximum width possible in a single stroke is equal to the length of the edge of the marker applied to the paper.

Artists may collect markers of different sizes and point configurations and choose among them to provide the sort of line desired. Lines that might be desirable can range from discrete thin lines to thick shaded patches that blend. The desired line may be dark or light. By abrading the ends of a marker, possibly breaking the marker into smaller pieces, points and edges are formed and sized by shaping the tool. This naturally results in smaller and smaller pieces of marker material. Where the marker material is apt to come off easily by any sort of contact (e.g., with so-called “soft” leads or other marking compositions), the results are messy. The artist's fingers accumulate material from contact with the marker and the work can become smudged.

Marker materials typically comprise a pigmented powdered material such as graphite, in a binder. The binders vary and might comprise dried or sintered clay, thermo-set or thermoplastic resins, or other materials. Examples of graphite in clay binders that are baked to assume a shape are disclosed, for example, in U.S. Pat. No. 5,801,215—Odashima, U.S. Pat. No. 5,118,345—Handl, U.S. Pat. No. 4,209,332—Tsujio. A chemical binder process for graphite is disclosed in U.S. Pat. No. 5,318,622—Kitazawa, et al. A range of compositions, including polymer binders, are disclosed in U.S. Pat. No. 4,268,411—Iwata et al. The disclosures of compositions and processes from these patents are hereby incorporated.

Pigmented markers for craftsmen such as tradesman, artists and the like, using a graphite or pencil material are possible in stick shapes (i.e., rectilinear bars) of exposed graphite and binder, but are most familiar in stylus shapes. The marking material is held in some sort of structure such as a wooden cover in the most conventional sort of known pencil, or a metal or plastic stylus shaped housing in a mechanical pencil. In U.S. Pat. No. 6,648,536—Bellue, an elongated stylus shape is disclosed having a cross section defining equilateral triangle and a helical twist along the axis of the device.

Examples of stylus holders that typically employ pens are found in U.S. Pat. No. 6,637,962—Roche et al.; U.S. Pat. No. 5,470,162—Rubin; U.S. Pat. No. 4,588,317—Taylor; and U.S. Pat. No. 3,994,605—McKnight. These devices are sometimes described as ergonomic in that the shapes of the housings carrying the marking material are somehow shaped for gripping, and thus differ from the typical elongated stylus, e.g., approximately 1 cm. in diameter by 12 to 15 cm. length. The functional marking portion in each case is simply a point.

### SUMMARY OF THE INVENTION

It is an object of the invention to provide a marking tool that is useful as a pencil marker to form narrow lines and the like, or as a special purpose marker for craftsmen, artists and artisans.

It is a further object to provide a marking tool that is particularly durable, and thus suited for use by craftsmen and tradesmen such as building construction trades.

Another object is to provide a marker or tool that is more useful than a charcoal or graphite “stick,” particularly for making relatively broad lines and marks, shaded areas, and for making rubbings on sheet material from bas-relief patterns.

For this purpose, the marker tool is advantageously configured to facilitate manual application to a paper or other substrate such that pigmented material that is abraded from the tool and deposited onto a workpiece varies in amount deposited per unit area (i.e., varies in darkness) across the width of a mark that can be applied in at least some modes of use of the marker tool.

Another object is to provide a tool that has plural useful edges, surfaces, points and curves that enable the same marker to apply marks of various characters.

A further object is to provide such a tool in a manner that is structurally uncomplicated insofar as possible, and readily manufactured.

Still another object is to provide a marker with pigment material carried in a binder that is quite hard, but is still capable of making marks. In this way, the pigment material need not be encapsulated. Furthermore, the marker tool has various edges that are useful in making marks. By providing a hard composition and various useful edges, the marker is versatile and can be used for a long time without the need for re-edging (sharpening).

The marker preferably comprises a graphite pigment material in a binder that renders the marking material relatively hard. This is useful in retaining the sharpness of edges and corners after used. The sharpness of the edges and/or corners can be refurbished after use by applying a tool such as a file or rasp; however the tool is configured to minimize the need for such refurbishment.

These and other objects are provided in a marking tool comprising a pigmented material formed into an integral marker tool shape, wherein the marker tool shape comprises a substantially planar body having spaced faces defining a body thickness, and spaced peripheral sides, a plurality of edges and corners being formed between the faces and sides, at which the body can be applied to a surface to be marked with the pigmented material. The edges include corners formed between adjacent ones of said edges and faces, at which at least three said edges and faces meet at an angle and form a point. The edges include at least three different configurations of segments that are selectively deployable along the body thickness, along spaced lines between a junction of said faces and one of the sides, and at least at four said corners.

In an exemplary and nonlimiting embodiment, the marker can be embodied by an integrally extruded nitrile rubber binder blended with powdered graphite. The nitrile binder may be sulfur cured or peroxide cured. The cured hardness of the marker material preferably ranges between about 50 Shore D and 90 Shore D hardness. The binder is hard, robust and not easily broken. Encapsulation is possible but is not really required to protect from unwanted marks due to contact with the fingers or with areas of a workpiece that are not intended to be marked. However the hardness is not so great as to prevent wear with abrasion of the marker over the work so as to leave marks.

The entire integrally shaped marker can be used to apply marks to the work. The darkness and width of the line made can be varied by pressure and by varying the orientation of the marker. Although a relatively hard composition is advantageous, the marker can also be embodied using a softer binder. A softer binder produces a composition that is relatively more easily abraded, and therefore a darker mark. A harder binder produces a lighter mark because the composition is less easily abraded. The nature and proportions of the composition also can be otherwise varied, as shown by the references cited above.

A number of additional objects and aspects will be apparent from the following discussion of certain non-limiting examples and embodiments.

### BRIEF DESCRIPTION OF THE DRAWINGS

The drawings depict one or more examples and embodiments as presently preferred. Reference should be made to the appended claims as opposed to the drawings to determine the scope of the subject invention. In the drawings,

FIG. 1 is a perspective view of a marking tool according to an exemplary embodiment of the invention;

FIG. 2 is an elevation view thereof, from a wider side generally designated herein as a “face.”

FIG. 3 is an end elevation view as seen from the right in FIG. 2.

FIG. 4 is a bottom view relative to FIG. 2.

FIG. 5 is a schematic illustration of an exemplary manufacturing technique for producing the product.

FIG. 6 is a schematic illustration showing application of the marking tool to a sheet material.

### DETAILED DESCRIPTION

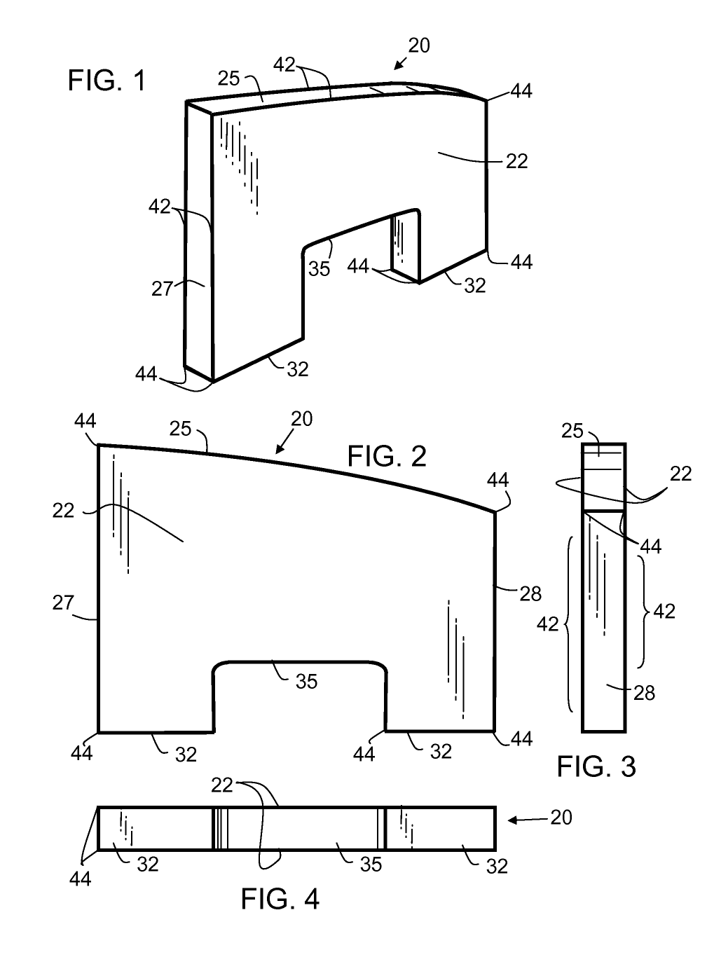

The invention as generally shown in FIGS. 1 to 4 is a marking tool that generally comprises an integral piece of material similar to the bonded graphite pigment of a pencil lead, but having a slab shape that is characterized by certain edges and corners that render the marking tool particularly useful for craftsmen, artists and artisans. The tool is useful for drawing, in certain respects as a pencil and in other respects as a charcoal or graphite stick. However the marking tool is preferably made of a hard and durable bonded pigment, similar to hard pencil lead material used in stylus pencils. The marker thus forms a slab-shaped tool with corners and edges defining points. By virtue of its hard bonded graphite pencil lead material, the marker is made of and point retaining marker for carpenters, masons and the like, as a tracing tool for recording the contours of bas-relief sculptures through paper, and generally is useful for drawing and marking.

Referring to FIG. 1, the marking tool in the example shown comprises a slab 20 of pigmented material. The marking tool preferably is an integral slab of homogeneous marker material. The material can be formed according to one or more of the techniques discussed and incorporated in the background section above, wherein a powdered pigment material is bonded with or suspended with a carrier of clay or resin or other material.

A preferred marker composition can be extruded with a perimeter shape as described in more detail below, having several discrete selectable marking edges. The shape is sliced into slabs forming the individual markers. An advantageous binder comprises a nitrile rubber binder blended with powdered graphite to provide an integral marker body.

In addition to providing a durable binder, nitrile rubber, i.e., poly(acrylonitrile-co-1,3-butadiene), is reinforced by the addition of appropriate graphite, carbon black or mineral pigments. The nitrile can be sulfur cured, peroxide cured, etc. Vulcanizing the nitrile results in high hardness. An advantageous proportion of graphite is about 40% to 60% weight of graphite in the nitrile/graphite composition. A #39 graphite particle size is preferred, but other sizes are also possible.

The darkness of the mark made with the tool is affected by the hardness of the binder, with a softer binder leaving darker marks. The preferred marker hardness after curing preferably ranges between about 50 Shore D and 90 Shore D. The binder is thus so hard that encapsulation is optional. However this hardness is still soft enough that applying the marker to a paper or other surface produces wear sufficient to leave adequate marks for trades involving marking of wood and stone workpieces, for handcrafts, for sketching, for rubbing to record bas-relief patterns and so forth.

The entire piece integrally forms the marker. The darkness and width of the line made can be varied by varying the hardness of the binder, particularly in the range of hardness noted, with a softer binder making darker lines, in a manner similar to stylus pencils. Unlike stylus pencils, numerous longer or shorter edges and surfaces are provided around the perimeter of the integral marker, and can be deployed in a versatile manner to make desired lines and shaded marks.

In a preferred embodiment, the marker is dimension to be easily held in a human hand and manipulated with the fingers. As such, the overall slab dimensions are about two inches in height, 2.75 inches in width and 0.30 inches in thickness. However, the slab is specifically shaped not only to be easily grasped and held, but also to maximize the number of opportunities for using the tool along its various corners and edges, for drawing procedures. Such procedures including drawing fine lines, thick lines, shading and fill, tracing and rubbing to reproduce on a sheet the contour of an irregular underlying surface.

As shown in the drawing figures, the marker tool or slab 20 has substantially planar body portion 22 with spaced wider-side faces 22, which in this embodiment are flat and parallel. The spacing between faces 22 defines a body thickness. The body is bounded by spaced peripheral sides or ends, namely at longer and shorter opposite ends 27, 28 of the wider side faces 22. The connecting sides or surfaces are the top side 25 and at a bottom side formed by two spaced feet or bottom sides 32, located on either side of an indented gap 35.

In the embodiment shown, the opposite faces 22 are parallel and spaced. The longer and shorter ends 27, 28 are parallel to one another and perpendicular to faces 22. One or both of ends 27, 28 could comprise angularly converging edges (not shown), to produce another set of points and edges that are deployable for marking.

The top side 25 and the boundary surfaces forming the feet 32 and the gap 35 likewise are oriented in planes perpendicular to faces 22. The result is a slab shape wherein a plurality of right angled edges 42 and corners 44 are formed between the faces 22 and the respective sides at the top 25. The edges 42 and corners 44 are points at which the body can be applied to a surface to be marked with the pigmented material that is bonded in the material of the tool.

In this embodiment, most of the faces and sides are flat and orthogonal to one another, which forms the edges 42 and the corners 44 as right angles between adjacent ones of said edges and faces. The edges 42 are provided where two perpendicular surfaces intersect. The corners 44 are provided where three faces or sides meet at an angle and form a point. Although these structures are oriented orthogonally (forming a rectangle in a cross section through the tool 20), it would also be possible to angle selected faces and sides such that a cross section could be provided as a parallelogram or a triangle or another shape (not shown).

According to an inventive aspect, the edges 42 of the tool 20 include several different configurations of segments, at least three being shown. The differences among the segments permit the corners 44 to be deployed as marker points and the edges 42 to be employed as stroking applicators to leave a mark of a chosen width. The segment differences include different edge lengths, demonstrated by longer side 27 versus shorter side 28. Each of the longer and shorter sides 27, 28 forms four edges (two selectable edge lengths) and four corners at their intersections with the faces 22, and the top and bottom sides 25, 32.

In the embodiment shown, the top surface 25 is curved. In this example, the radius of curvature over the top surface 25 is about 15 inches in an embodiment with a 2.0 by 2.75 area for face 22. The curve also is canted relative to a centerline of the marker, so as to provide a difference in height for ends 27, 28.

The gap 35 between the of the feet 32 defined an indent distance of about 0.5 inch, and the width of the gap is about 1.25 inch, which can comfortably receive one or two fingers. The edges of the gap are also perpendicular and orthogonal. The edges at the feet 32 are deployable to apply a mark to paper or another substrate, but the inner surfaces at the gap 35 are not directly used in marking. These inner surfaces are helpful for gripping the tool.

The disclosed embodiment has numerous corners and edges that are selectively deployable, along the body thickness, along spaced lines between a junction of said faces and one of the sides, and at least at four said corners facing in each of six orthogonal directions. The edges and faces are of sufficient number and orientation to provide more than six surfaces and eight points. By providing numerous deployable edges and corners (points), this marker configuration advantageously reduces the rate at which the marker becomes dull and requires sharpening, compared to other markers. The relatively hard character of the marker material (50 to 90 Shore D) also helps to keep the edges sharp. In regular use for marking, the marker can be routinely sharpened by making a habit of using the marker on evenly shaded areas so that the sides on the smaller width edges (sides 27, 28, top 25, etc.) are oriented parallel to the plane of the sheet or other material to be marked, thereby sharpening the adjacent edges when shading is applied.

In the embodiment shown, the sides 27, 28, top 25 and foot surfaces 32 are exclusively in a plane perpendicular to the faces 22. In an alternate embodiment wherein one or more of these surfaces forms an acute or obtuse angle at an edge (not shown), the same sharpening effect can be obtained by holding the surface plane parallel to the workpiece surface.

In the example of FIGS. 1-4, the top surface 25 is curved. Preferably, at least one of the edges and surfaces defines a curve, and it is possible to include plural curves. It is also possible to provide surfaces that converge at 90 degrees as shown, or at acute or obtuse angles, making the surface junctions useful as various types of points.

Also in this example, the edges include at least two segments, namely feet 32, which segments are spaced from one another. The two feet are substantially parallel structures as shown in FIG. 2. The feet could also be directed outwardly at distinct angles, or arranged such that their bottom surfaces are inclined at angles from a point midway in the gap, upwardly from the centerline in one or both directions toward the end walls. Such an inclined permits the longer bottom edges of the feet segments to be deployable individually at one of said edges and said points. For example, a star configuration (not shown) can be provided with a series of foot protrusions resembling feet 32, but angularly disposed around the marker structure. All or part of the marker can form a regular or irregular polygon whereby each junction defines a point and each length between junctions defined an individually deployable marking edge.

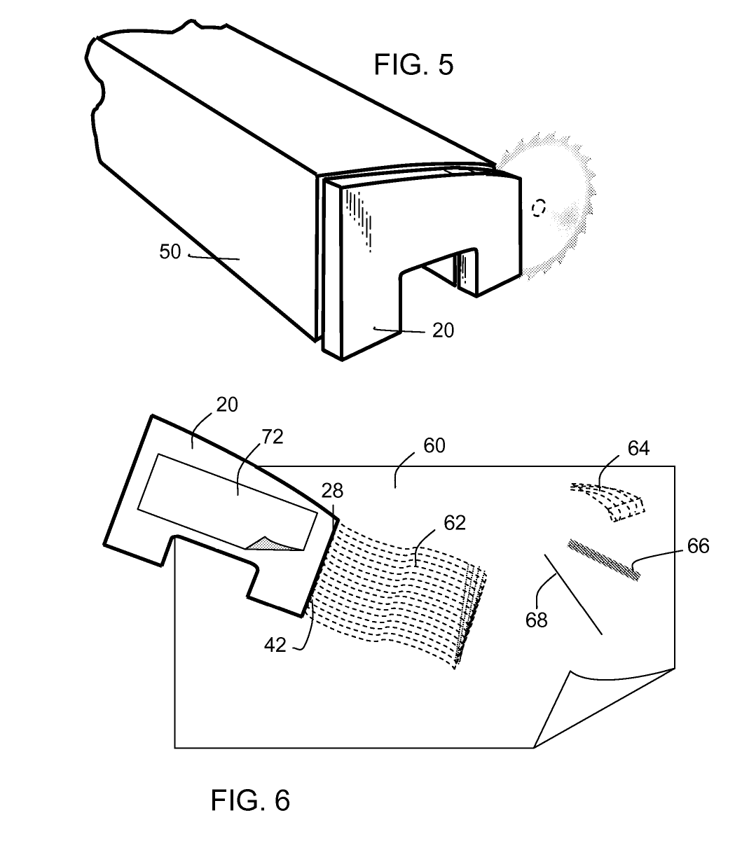

As discussed above, the material of the marker can be graphite with a binder such as a clay binder with which the graphite is mixed and baked, or a resin or other binder, provided that frictional application of the marker to a paper or wood or concrete or stone or other surface leaves some marker material behind. The material can be molded or extruded to form a blank 50 with a cross section as shown in FIG. 2, this step being generally shown in FIG. 5. The individual marker slabs 20 are cut from the blank to provide the slab shape as shown.

An advantageous marker composition as discussed, uses an extruded nitrile rubber binder blended with powdered graphite. The nitrile binder is sulfur cured or peroxide cured to a hardness ranging from about 50 Shore D to 90 Shore D. The binder is thus quite hard. Encapsulation is not required to guard from unwanted marks or undue dirtying of the fingers, but the marker is not so hard as to prevent wearing off of the graphite powder so as to leave marks. The entire piece can be used as a marker in various orientations and using selected points and edges for producing variations in shade across a line or other mark. The marker can be made available in relatively softer and harder variations for meeting user preferences, preferably within the stated hardness range but potentially also of a softer composition to obtain darker marks (other things being equal) or yet harder compositions, e.g., for marking particularly abrasive materials such as stone or concrete.

FIG. 6 shows that the marker 20 can be applied usefully to make a variety of marks on a paper 60 or other workpiece. The marker 20 is shown being drawn in a direction perpendicular to an edge 44, in this example the short side 28. As shown by converging mark 64, it is possible to vary the width of the mark by inclining the tool edge relative to the direction in which the tool is moved. By choosing a short edge and/or adjusting the inclination of the edge relative to the direction of advance of the tool, a relatively wider mark 62 or narrower mark 66 is possible, down to a narrow line 68, which likewise can be made by applying a corner of the tool to the paper or other substrate.

The marker 20 in FIG. 6 is shown with a covering strip 72, which can be provided on the faces 22 where the tools is often grasped. This reduces the extent to which the user's fingers will be marked by the material. Additionally, using a relatively hard “lead” composition (graphite and binder) helps to control marking of the user's fingers.

What is claimed is:

1. A marking tool comprising:
a pigmented material formed into an integral marker tool shape;
wherein the marker tool shape comprises a substantially planar body having spaced faces defining a body thickness, and spaced peripheral sides, a plurality of edges and corners being formed between the faces and sides, at which the body can be applied to a surface to be marked with the pigmented material;
wherein the edges include corners formed between adjacent ones of said edges and faces, at which at least three said edges and faces meet at an angle and form a point;
wherein the edges include at least three different configurations of segments that are selectively deployable along the body thickness, along spaced lines between a junction of said faces and one of the sides, and at least at four said corners.

2. The marking tool according to claim 1, wherein the edges and faces are of sufficient number and orientation to provide more than eight points.

3. The marking tool according to claim 1, wherein the edges and faces include parallel and orthogonal surfaces, whereby the points include rectilinear corners.

4. The marking tool according to claim 1, wherein the edges are substantially in a plane perpendicular to the faces.

5. The marking tool according to claim 1, wherein at least one of the edges defines a curve.

6. The marking tool according to claim 1, wherein the edges include at least two segments that are one of spaced from one another and directed outwardly at distinct angles, such that the segments are individually deployable at one of said edges and said points.

7. The marking tool according to claim 1, wherein at least one of the edges is interrupted by a gap, thereby forming points at the gap.

8. The marking tool according to claim 1, wherein the pigmented material is graphite and further comprising a binder.

9. The marking tool according to claim 8, wherein the binder comprises a nitrile rubber.

10. The marking tool according to claim 9, wherein the binder comprises a nitrile rubber that is one of sulfur cured or peroxide cured.

11. The marking tool according to claim 8, wherein the pigmented material has a hardness of at about 50 Shore D to 90 Shore D.

12. A method of making a marking tool, comprising:
forming a block of pigmented material in a binder;
cutting the block into slabs having an integral marker tool shape having a substantially planar body having spaced faces defining a body thickness, and spaced peripheral sides, a plurality of edges and corners being formed between the faces and sides, at which the body can be applied to a surface to be marked with the pigmented material, wherein the edges include corners formed between adjacent ones of said edges and faces, at which at least three said edges and faces meet at an angle and form a point, wherein the edges include at least three different configurations of segments that are selectively deployable along the body thickness, along spaced lines between a junction of said faces and one of the sides, and at least at four said corners.
